(19) United States
(12) Patent Application Publication
(10) Pub. No.: US 2011/0059267 A1
(43) Pub. Date: Mar. 10, 2011

(54) SURFACE TREATMENT OF SILICON NANOPARTICLES

(75) Inventors: Nathalie Chantal Marie Herlin-Boime, Orsay (FR); Vincent Marc Maurice, Paris (FR)

(73) Assignee: COMMISSARIAT A L'ENERGIE ATOMIQUE ET AUX ENERGIES ALTERNATIVES, Paris (FR)

(21) Appl. No.: 12/990,842

(22) PCT Filed: May 5, 2009
(86) PCT No.: PCT/FR09/50831

§ 371 Date: Nov. 3, 2010

(30) Foreign Application Priority Data
May 6, 2008 (FR) 0853008

(51) Int. Cl. B05D 3/06; B05D 3/00

(52) U.S. Cl. 427/553; 427/299; 427/600

(57) ABSTRACT

The present invention relates to the treatment of photoluminescent silicon nanoparticles in order to give them surface functionalities, for example amine radicals or other radicals, that favor their use especially in biology for labeling applications. A reaction is then applied to the nanoparticles in order to create a surface coating that gives the nanoparticles these functionalities, especially a protection against dissolution in an aqueous medium. The process comprises, prior to this coating reaction, a passivation of the silicon nanoparticles that favors the creation of bonds of Si—OH type at the surface, this type of bond making it possible to obtain a multiplicity of functionalities including, in particular, amines, thiols, polyethylene glycol, as surface radicals.

### TECHNICAL FIELD

The present invention relates to a method for making and treating nanoparticles having surface properties giving them stability in aqueous medium.

### CONTEXT

The synthesis of nanoparticles is often the first step in the preparation of nanotechnology devices. Laser pyrolysis is a flexible method for synthesizing such nanoparticles and has, in particular, allowed the synthesis of silicon nanocrystals. Silicon, in the form of a powder of crystalline nanograins, has photoluminescence properties. The photoluminescence attributed to the quantum confinement phenomenon is observed when the silicon grain size is reduced to nanometer scale (size lower than 10 nm) and the color observed by photoluminescence effect varies with the size of the nanoparticles.

This property, observable at ambient temperature and in the visible domain (the photoluminescence emission wavelength being a function of the size of the nanoparticles), has set the stage for potential applications in a wide variety of fields, such as photonics (silicon lasers), biology (tagging agents or tracers), the detection of fakes (optical barcode), cosmetics, etc.

The development of devices based on such nanoparticles requires a good control and guaranteed reproducibility of the properties. Their use for biological systems in particular demands the preparation of suspensions that are stable in aqueous medium. A surface treatment of the nanoparticles to give them a surface function (treatment referred to below as “surface functionalization”) is a necessary step, and few procedures are available for producing silicon nanoparticles that can be dispersed while remaining stable in aqueous medium.

In fact, silicon nanoparticles produced by laser pyrolysis, for example, and untreated, become soluble in aqueous medium: they are naturally converted to silica.

To prevent this dissolution, it is known to coat the nanoparticles with a surface protection layer. For this purpose, the nanoparticles are passivated after their synthesis, to reduce their defects and, in particular, to saturate their pendent bonds, especially at the surface. Photoluminescence normally already appears at this stage. Then, the surface sites comprising bonds of the SiH type, for example, are used to accommodate protective molecules forming the coating layer. The nanoparticles, thus protected by this layer, become insoluble in aqueous medium.

### PRIOR ART

Various techniques can be used to synthesize silicon nanoparticles. These particles can be obtained directly in suspension by a chemical method, by attack followed by scraping from solid silicon, or by methods called “gas methods” like plasma synthesis or by laser pyrolysis.

The possibility of using surface bonds to functionalize silicon surfaces is known in the prior art. In particular, the known prior art describes the functionalization on silicon nanoparticles essentially from SiH surface bonds. A technique is described in particular in the document: “Photoluminescent Silicon Nanocrystals with Mixed Surface Functionalization for Biophotonics”, Folarin Erogbogbo and Mark T. Swihart, Mater. Res. Soc. Symp. Proc. Vol. 958, Materials Research Society 0958-L08-08 (2007).

This document describes the grafting of various types of alkenes on silicon nanoparticles. It uses silicon nanoparticles produced by laser pyrolysis and treated by HF/HNO₃ attack. It then takes advantage of the presence of the SiH surface bonds to graft the alkenes. Placement in aqueous medium can then be effected.

However, such a method, comprising several chemical treatment steps followed by rinsing and/or drying, is particularly complicated to implement.

The present invention improves the situation.

### PRESENTATION OF THE INVENTION

For this purpose, the invention proposes a method for treating silicon nanoparticles to give the nanoparticles surface functionalities. In particular, a reaction is applied to the nanoparticles to create a surface coating that gives the nanoparticles these functionalities. This step can, for example, consist in creating radicals on the surface of the nanoparticles, such as for example:
an amine NH₂,
a thiol SH,
a polyethylene glycol.

However, such surface radicals can only be obtained (easily) using a different chemistry from that of the alkenes described in Folarin et al., as explained below.

Advantageously, the inventive method, prior to the reaction for creating such radicals, comprises a passivation of the silicon nanoparticles to favor the creation of SiOH type bonds at the surface of the nanoparticles.

Thus, the present invention proposes a method that is extremely simple to implement in comparison with the prior art: a simple passivation of the defects of the nanoparticles serves to generate SiOH type surface bonds. Then, the inventive method, starting with nanoparticles having SiOH surface bonds, serves to obtain a wide choice of functions available for a surface top-grafting during the abovementioned reaction step to create the coating. It is then possible additionally to give the nanoparticles a stability in aqueous medium after this coating step, thereby preventing a dissolution of the nanoparticles.

In the Folarin et al. document of the prior art, the nanoparticles obtained are of relatively large size (5 to 10 nm) and do not have photoluminescence. They are then attacked by abrasion (HF/NO₃) to reduce their size. However, this method causes saturation of the pendent surface bonds by hydrogen atoms (SiH). The only possible protective coatings for grafting on the SiH surface sites are obtained from alkenes, offering fewer potential functionalities than coatings which can be obtained from organosilanes, as in the context of the invention (for example, 3-aminopropyltriethoxysilane), while, on the other hand, these coatings obtained from the organosilane family can generate NH₂ amine radicals, polyethylene glycol radicals, SH thiol radicals, or even other radicals sought in biotechnology.

Other features of the inventive method have proved to be advantageous. For example, the synthesis of the nanoparticles by laser pyrolysis in the sense of French application FR-07 03563 has served to obtain homogeneous nanocrystals smaller than 5 nm in diameter. Thus, no attack by abrasion was necessary. The passivation of the nanoparticles, after synthesis, could be carried out:
dry, simply in the ambient air (but leaving the particles in the open air for a few months),
or even in a liquid medium comprising at least one alcohol (preferably ethanol) to saturate the pendent SiOH surface bonds, and during a few weeks only.

After passivation, the nanoparticles can be treated by coating using a reaction between the SiOH surface bonds and an organosilane, to be thereby “functionalized”. During this reaction step, radicals, for example of the polyethylene glycol type, NH₂, or other radicals, are created at the surface of the nanoparticles, these surface radicals giving the nanoparticles bonding properties for bonding with other molecules, which are favorable for biology applications.

In the case of passivation in liquid medium in particular, it is advantageous to subject the particles regularly to vibrations of a high-power ultrasonic probe, in order to separate the grains and disperse them as well as possible in order to free their surface for its treatment. It has advantageously appeared that passivation in ethanol with a chosen portion of added water yielded highly satisfactory results.

In the case of passivation in the open air, it has been observed that a thin surface layer of silica was already formed naturally (SiO₄ type surface bonds), which may already suffice to protect the nanoparticles from dissolution in water. Also in this case, however, SiOH surface bonds are created, and these bonds are advantageously usable for a functionalization of the nanoparticles (creation of NH₂ radicals at the surface in particular, as described below).

In either of the passivation modes (open air or liquid medium), the surface bonds which have been mainly observed are of the SiOH, Si(OH)O₃ (silanol), SiH₂OH, SiHO₃ type, with a simple presence of SiH. In the general presentation of the invention given above, the term “SiOH type bond” also implies that the surface bonds include O—H bonds, such as SiOH, and also Si(OH)O₃, SiH₂OH, SiHO₃, etc.

Furthermore, it has been observed advantageously that, for nanoparticles passivated simply in dry air, the application of ultraviolet radiation to said nanoparticles considerably increased their photoluminescence, in particular when they were immersed in water in order to be subjected to this radiation. One explanation of this phenomenon is that the radiation treats the grains photochemically, thereby increasing their passivation.

It has also appeared that the nanoparticles:
passivated in liquid medium (for example in a mixture of ethanol and water),
then treated by reaction (for example with an organosilane) to be functionalized,
then immersed in water,
   have similarly exhibited an increase in their photoluminescence properties by undergoing ultraviolet radiation a posteriori.

Thus, it is still possible to passivate defects and increase the photoluminescence of the nanoparticles after treatment by protective coating.

It will be understood that the passivation of the nanoparticles by exposure to ultraviolet radiation is independent of a particular order in the nanoparticle treatment process. In this respect in particular, this passivation treatment by exposure to ultraviolet radiation can be the subject of an independent protection.

The present invention relates to the application of ultraviolet radiation in order to passivate defects in silicon nanoparticles. The nanoparticles are preferably immersed in water to undergo this radiation.

### BRIEF DESCRIPTION OF THE APPENDED DRAWINGS

Other features and advantages of the invention will appear from an examination of the detailed description below, and the appended drawings in which:

FIG. 1 shows the comparative effect of ultraviolet radiation on the photoluminescence measured on silicon nanoparticles left for zero seconds (curve A), thirty seconds (curve B), one minute (curve C), three minutes (curve D), five minutes (curve E), ten minutes (curve F) and twenty minutes (curve G) under radiation,

FIG. 2 is an infrared spectrum of the nanoparticles after reaction to create a protective coating,

FIG. 3 shows an increase in the photoluminescence measured on nanoparticles passivated by residence in ethanol, just after the functionalization reaction (curve A) and four days after the reaction (curve B),

FIG. 4 shows an increase in the photoluminescence measured on nanoparticles passivated by residence in the open air, just after the functionalization reaction (curve A) and four days after the reaction (curve B).

### DETAILED DESCRIPTION

### Synthesis of the Nanoparticles

In the example described, silicon particles are synthesized by laser pyrolysis by the method described in French application FR-07 03563 in the name of the applicant. In this document, a laser ray having a chosen power and, preferably, chosen pulse duration, interacts with a flux of precursors such as silane, for example, to obtain silicon nanocrystals.

An advantageous geometry of the interaction zone between the laser ray and the precursor flux has yielded good results. In particular, an optimization of the focusing parameters has further improved the production of nanocrystals, while decreasing their size. This result is obtained by employing laser beam focusing means using one or two cylindrical lenses, and, in the case of the use of two lenses, the focusing planes are preferably intersecting in order to adjust the vertical and horizontal dimensions of the spot in the reaction zone independently, by adjusting the distance of each lens from the reaction zone. The best result is obtained for a spot with a height of 0.5 mm and a width of 3 mm (measured experimentally) in the experimental conditions of FR-07 03563.

The production rate was thus increased from 80 mg/hour for 4 nm diameter nanocrystals to over 200 mg/hour for nanocrystals in the 3-4 nm diameter range.

### Passivation

The nanoparticles obtained are then collected by scraping on filtering barriers. SiH, SiH₂ bonds can be identified at the surface of the nanoparticles, but the nanoparticles do not yet have photoluminescence. The photoluminescence only appears after passivation of the surface defects. One possible passivation method consists in coating the nanoparticles with a layer of silica, with the presence of SiOH bonds at the surface of the particles. The particles are passivated here after synthesis by two alternative methods:
dry, by simple exposure to air,
or in liquid medium by dispersion in 95% ethanol.

### *Dry Passivation

The passivation of the surface consists of an oxidation to remove surface defects which prevent photoluminescence. Passivation in air is slow and may take several months. After each passivation step, the luminescent particles can be dispersed in various liquid media, such as ethanol, water or DMSO (for “dimethylsulfoxide”), using a high power ultrasonic probe and at a concentration between 0.5×10⁻³ and 0.1 g.L⁻¹.

It has appeared that irradiation by low power ultraviolet radiation (6 W DC lamp) has a positive effect on the photoluminescence intensity on dry particles, and also on particles passivated dry and then dispersed in liquid medium, particularly in water.

FIG. 1 shows this effect. The photoluminescence intensity has increased with the illumination time in the course of about 20 minutes.

### *Passivation in Liquid Medium

The concentration of the dispersions in ethanol is preferably lower than 0.1 g of nanoparticles per liter. In the example described, the dispersion is prepared using a high power ultrasonic probe (750 W) shortly after synthesis. It is necessary to use such a probe to ensure a proper dispersion of the nanoparticles (transparent suspension without presence of aggregates discernible to the naked eye). A significant photoluminescence then appears.

Passivation in alcohol may take a few weeks to obtain photoluminescent particles. It appears that the photoluminescence can be correlated with the presence of water in the alcohol. In 95% ethanol (including 5% water), the photoluminescence appears naturally and it is unnecessary to add water.

In water-free solvents, such as absolute ethanol, the effect of a quantity of water of between 50 and 100 microliters of water in 9 ml of absolute ethanol has also yielded satisfactory results, shown in Table I below. It may be observed that the photoluminescence obtained effectively varies as a function of the water content of the alcohol.

TABLE I
Example showing the effect of the presence
of water in ethanol for passivation

| | Photoluminescence at a |
|---|---|
| | wavelength of 680 nm in |
| Solvent | arbitrary intensity |
| Absolute ethanol | No |
| Absolute ethanol + 0.5% vol. water | 20 |
| Absolute ethanol + 1% vol. water | 25 |
| Absolute ethanol + 1.1% vol. water | 40 |

Other tests have demonstrated an effective passivation of non-radiative defects in the silicon particles (with a sharp increase in the intensity of the photoluminescence signal after only 3 hours of treatment) when they were dispersed in an acidic water containing H⁺ ions. The pH was about 5 or 6. This observation suggests that the role played by the H⁺ ion, by dispersion of the nanoparticles in slightly acidic aqueous medium, is important for passivation. However, care must be taken to avoid converting the silicon nanoparticles to silica by leaving them too long in aqueous media. In consequence, it is preferable for the dispersion time and/or the quantity of water in the dispersion to be controlled and optimized. In this respect, the satisfactory results obtained with the mixture of alcohol and water (controlled quantities) given in Table I above, can be explained by a controlled presence of the H⁺ ion in the dispersion.

### Functionalization of Silicon Nanoparticles

Functionalization can then be carried out on particles passivated in air or on particles passivated in alcohol.

The nanoparticles provided before their functionalization can be dispersed in ethanol or in DMSO. In fact, the particles are dispersed in the solvent finally selected for the reaction, using a high power ultrasonic probe and at a concentration between 0.5×10⁻³ and 0.1 g.L⁻¹. The particles are dispersed shortly before the reaction in the case in which passivation in air has been previously carried out. On the other hand, they are dispersed several weeks before the reaction (from the synthesis) in the case of passivation in ethanol.

The reaction is carried out in the presence of water, in the case in which absolute ethanol or DMSO is used. It may in fact prove advantageous to add a certain amount of water (about 5 mol.L⁻¹). Typically, a volume of 100 μL of water can be added to 10 mL of solvent. In the case of 95% ethanol, it has proved unnecessary to add water.

The reactant, preferably an organosilane, providing the function to be grafted, is introduced in excess in a molar ratio of 5 to the silicon of the nanoparticles. For example, about 10 μL of 3-aminopropyltriethoxysilane (“APTS” below) sold by Sigma-Aldrich® can be added. It is possible to add even more reactant. The catalyst employed for the reaction can advantageously be ammonia, for example in a concentration close to 0.3 mol.L⁻¹.

The reaction mixture is then stirred for 10 to 12 hours.

After reaction, the particles are separated from the medium by centrifugation (4500 rpm for 15 min), and washed twice with ethanol, and then with a 1:1 ethanol:ether mixture, to remove the residue of ungrafted reactant.

After each washing, the particles are recovered by centrifugation (4500 rpm for 15 min).

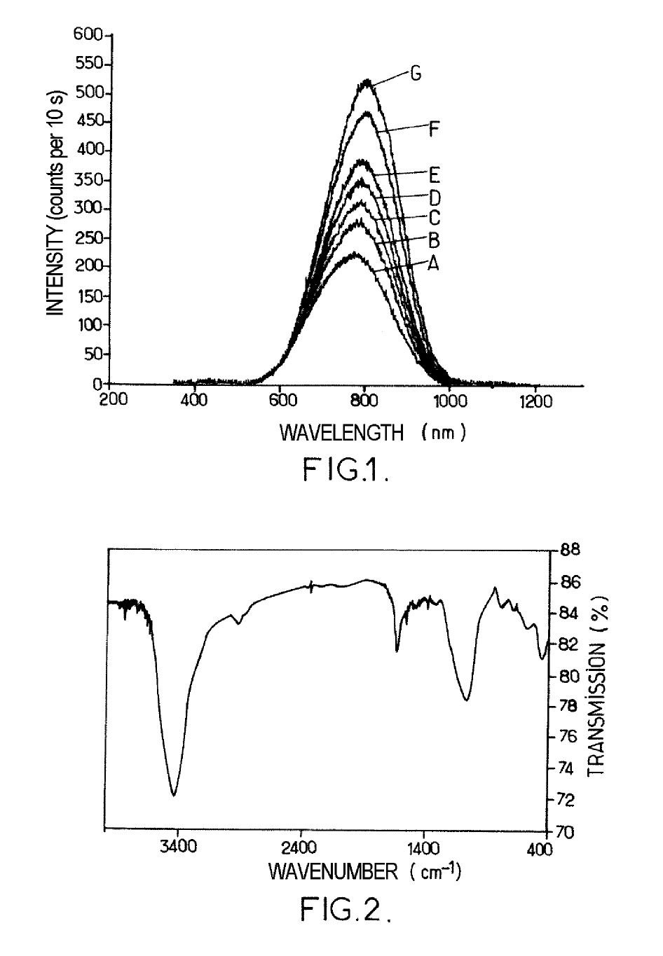

FIG. 2 shows an infrared spectrum measured on nanoparticles top-grafted with APTS. The presence of typical CH bonds of carbon compounds of APTS can be observed (lines at 2930 and 2860 cm⁻¹).

Once the particles are washed, they are redispersed in acidified distilled water. They then form suspensions in aqueous medium that are stable for several weeks.

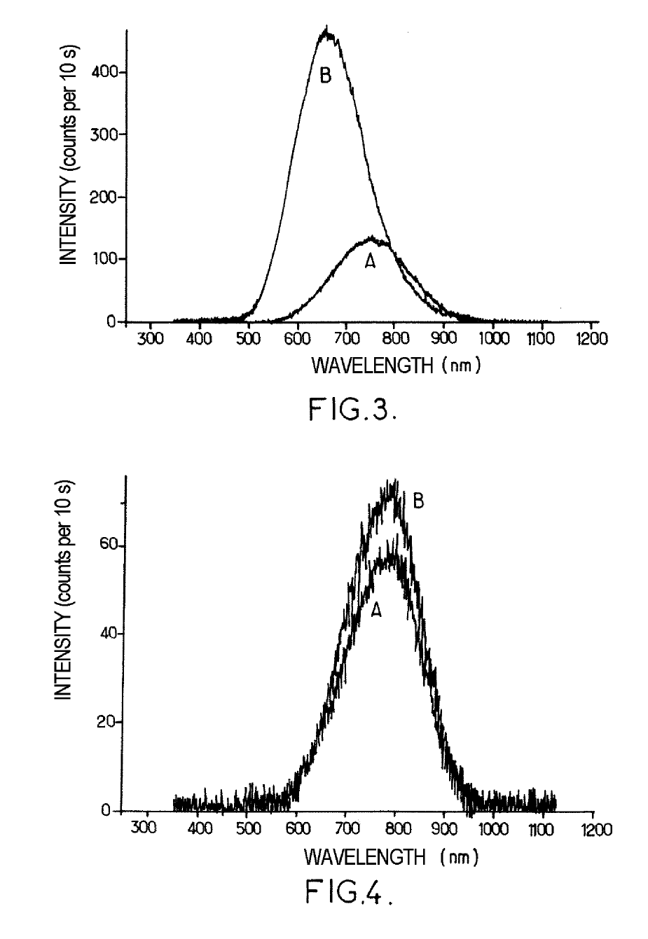

FIGS. 3 and 4 show photoluminescence spectra in aqueous medium after APTS grafting respectively on particles passivated in ethanol and on particles passivated dry.

Obviously, the present invention is not limited to the exemplary embodiment described above; it extends to other alternatives.

For example, it is possible to graft other types of compounds than APTS on the passivated nanoparticles, for example such as mercaptopropyltrimethoxysilane, alkyltriethoxilsilane, or others. Co-graftings can also be provided, to favor several radicals and to control their respective proportions in the coating of the particles, for example a mixture of NH₂ (amine), SH (thiol) and polyethylene glycol radicals, having different functionalities in biology applications.

1. A method for treating silicon nanoparticles in order to give them surface functionalities, comprising:
applying a reaction to the nanoparticles to create a surface coating that gives them said functionalities,
wherein, prior to said reaction, the method comprises passivating of the silicon nanoparticles to favor the creation of SiOH type bonds at the surface of the nanoparticles.

2. The method as claimed in claim 1, wherein said reaction creates a protective coating giving the nanoparticles stability in aqueous media and prevents a dissolution of the nanoparticles.

3. The method as claimed in claim 1, wherein, during said reaction, said surface functionalities are obtained by creating radicals at the surface of the nanoparticles, comprising an element selected from the group consisting of:
an amine NH₂,
a thiol SH,
a polyethylene glycol.

4. The method as claimed in claim 1, wherein the reactant used to create the surface coating is selected from the family of organosilanes.

5. The method as claimed in claim 4, wherein the said reactant comprises 3-aminopropyltriethoxysilane.

6. The method as claimed in claim 1, further comprising initially obtaining the nanoparticles by laser pyrolysis, before the passivation step.

7. The method as claimed in claim 1, further comprising carrying out the passivation step in aqueous medium.

8. The method as claimed in claim 7, wherein aqueous medium is slightly acidic.

9. The method as claimed in claim 1, wherein the passivation step is carried out in a liquid medium comprising at least one alcohol.

10. The method as claimed in claim 9, wherein the liquid medium comprises about 95% of ethanol and about 5% of water.

11. The method as claimed in claim 9, wherein the passivation step lasts a few weeks.

12. The method as claimed in claim 1, wherein the passivation step is carried out in the open air.

13. The method as claimed in claim 12, wherein the open air passivation creates a silica layer at the surface of the nanoparticles, for protection to prevent a dissolution in aqueous medium.

14. The method as claimed in claim 12, wherein the passivation step lasts a few months.

15. The method as claimed in claim 1, further comprising stirring, during this passivation step, the nanoparticles by ultrasound.

16. The method as claimed in claim 1, further comprising subjecting, at least during the passivation step, the nanoparticles to ultraviolet radiation.

17. The method as claimed in claim 1, further comprising subjecting the nanoparticles comprising said surface coating to ultraviolet radiation, to continue their passivation treatment after the reaction step.

18. The method as claimed in claim 16, further comprising immersing the nanoparticles in water during the application of said radiation.

19. A method for treating silicon nanoparticles in order to give them surface functionalities, comprising:
applying ultraviolet radiation to passivate defects in silicon nanoparticles.

20. The application as claimed in claim 19, further comprising immersing the nanoparticles in water.
